(19) United States
(12) Patent Application Publication
(10) Pub. No.: US 2007/0001828 A1
(43) Pub. Date: Jan. 4, 2007

(54) Disabling device for vehicular use of communications device

(76) Inventor: Mark Martinez, Winton, CA (US)

Correspondence Address: KRAJEC PATENT OFFICES, LLC, 820 WELCH AVENUE, BERTHOUD, CO, 80513, US

(21) Appl. No.: 11/172,771

(22) Filed: Jul. 1, 2005

(51) Int. Cl. B60R 25/10

(52) U.S. Cl. 340/426.25

(57) ABSTRACT

A system and method for communicating on a network having multiple radios by substantially simultaneously transmitting a beacon signal from the radios. When a first radio receives a beacon signal from another radio, the first radio determines if the received beacon signal contains a priority designator. If the received beacon signal has a higher priority than that of the first radio, the first radio synchronizes subsequent transmission of its beacon signals to the other radio's beacon signal. In a network environment, radios may continuously adapt their beacon signals to transmit substantially simultaneously. Additionally, radios in a congested environment may coordinate beacon signals to minimize overhead use of bandwidth.

### BACKGROUND

a. Field

The present invention pertains generally to communication devices and specifically to communications devices that are partially disabled in certain situations.

b. Description of the Background

Cellular telephones are ubiquitous in our society, but can be a hazard when used while operating a vehicle. Even voice activated features of a cellular phone may cause a driver to become distracted during vehicle operation, substantially raising the potential for an accident. The problem is exacerbated for youngsters just learning how to drive, as they may not have the skills required to operate a vehicle proficiently on top of the complexities of operating a cellular telephone. Rates of vehicular accidents where cellular telephones are involved are rising, especially with teenagers.

### SUMMARY

The present invention provides a system and method for at least partially disabling the operation of a two-way communications device within an operable vehicle. When the vehicle is in an operational anode, such as when the ignition switch is activated or the transmission is moved from ‘Park’, a signal is sent to a communications device within the vehicle, fully or partially disabling the device. In some cases, a jamming signal may actively prevent two-way communications, while in other cases, the communication device may receive a signal and refrain from sending or transmitting communications while the signal is being received.

### BRIEF DESCRIPTION OF THE DRAWINGS

In the drawings,

FIG. 1 is a diagrammatic illustration of an embodiment showing a system for disabling communications devices inside a vehicle.

FIG. 2 is a diagrammatic illustration of an embodiment showing a system for selectively disabling communications inside a vehicle.

FIG. 3 is a timeline illustration for a sequence for jamming a communications device such as a cellular telephone.

FIG. 4 is a timeline illustration for a sequence for selectively jamming a communications device such as a cellular telephone.

### DETAILED DESCRIPTION

Specific embodiments of the invention are described in detail below. The embodiments were selected to illustrate various features of the invention, but should not be considered to limit the invention to the embodiments described, as the invention is susceptible to various modifications and alternative forms. The invention is to cover all modifications, equivalents, and alternatives falling within the spirit and scope of the invention as defined by the claims. In general, the embodiments were selected to highlight specific inventive aspects or features of the invention.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The invention may be embodied as devices, systems, methods, and/or computer program products. Accordingly, some or all of the invention may be embodied in hardware and/or in software (including firmware, resident software, micro-code, state machines, gate arrays, etc.) Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the invention is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement. “Comprising” leaves open for the inclusion of unspecified ingredients even in major amounts.

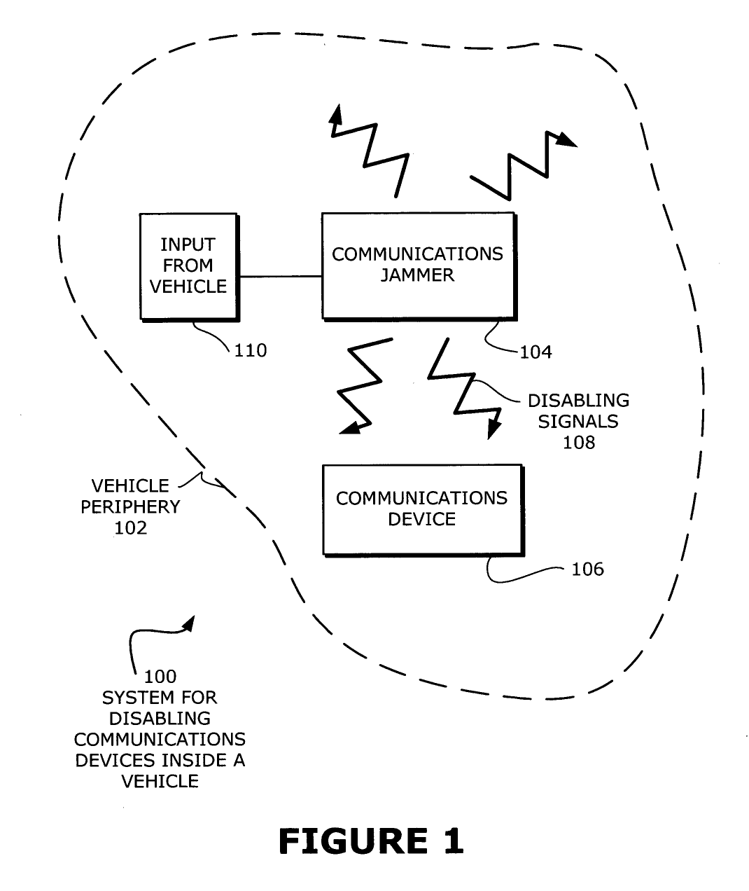

FIG. 1 illustrates an embodiment 100 showing a system for disabling communication devices inside a vehicle. Inside the vehicle periphery 102, a communications jammer 104 disables the communications device 106 by sending disabling jamming signals 108. The jammer 104 is controlled by an input 110 from the vehicle.

The embodiment 100 is a mechanism by which communications devices, such as cellular telephones, may be disabled during the time that a vehicle is operational. When used in an automobile, the embodiment 100 may prevent the driver of the automobile from talking on a cellular phone or other communications device while operating the vehicle. Such an embodiment may be particularly useful for juvenile drivers who are less proficient operators of a vehicle and whose inadvertent attention to a cellular phone may cause an accident to occur. When used in an aircraft, watercraft, or other vehicle, the vehicle operator may wish to force passengers to use the operator's communications devices that are not affected by the jamming signals.

The vehicle 102 may be any kind of transportation vehicle. For example, it may be any type of automobile, aircraft, watercraft, spacecraft, or any other vehicle where communications are to be disabled.

The communications jammer 104 may be any device that transmits a signal 108 that can cause interference or inoperability of the communications device 106. In some embodiments, the jammer 104 may broadcast noise or a specialized signal that is selected to interfere with one or more of the communications frequencies of the communications device 106. For example, the jammer 104 may broadcast noise or a repeated interfering signal on the control channel frequencies for a cellular phone system. In some cases, the jammer 104 may transmit on a narrow frequency band, while in other cases, a very broad frequency band may be selected. The precise method for interfering with the communications device 106 by the jammer 104 is dependent on the transmission and reception characteristics of the device 106. Those skilled in the art may use any appropriate jammer 104 for specific device 106 contemplated.

The input 110 from the vehicle may originate from any signal that is appropriate for the embodiment. In an example of a commercial airliner, a cockpit may be activated by one of the crewmembers such as the pilot, to disable communications devices. In an example of an automobile, an ignition switch or transmission position indicator may be used. In such embodiments, a ‘park’ indicator may be used. In other embodiments, a speed sensor may also be used to indicate that a vehicle is in a stopped position and communications operations are permitted.

In an automobile embodiment, the system may be used to prevent communications by the operator of the vehicle. In such cases, an ignition switch may cause the jammer 104 to broadcast, which would require the operator of the vehicle to shut down the vehicle to establish outside communications. When the operator started the automobile, the jammer 104 would prevent any further communications until the vehicle was switched off. In a similar embodiment, the jammer 104 may be activated when an automatic transmission in the vehicle is moved out of ‘park’ and into a position where the automobile may move. When such a system is in place, the operator of the automobile must stop the vehicle and either move the transmission to ‘park’ or turn off the engine to place a phone call.

The jammer 104 may be specially designed to work within the metal confines of a vehicle such as an automobile. In some cases, the jammer 104 may have an antenna design and power level setting to direct the jamming signals 108 merely in the area around the driver or front seat occupants. In such cases, the signals 108 may be generally confined within the vehicle. Similarly, when used within a commercial aircraft body, the jammer 104 may disable communication devices from being used by passengers. In some embodiments, the jamming signals 108 may be localized to certain areas within a vehicle so that operation of a device in that area is disabled, but leaving other devices outside of that area operational.

In some embodiments, the jammer 104 may permit incoming calls but prohibit outgoing calls. The jammer 104 may detect an attempted outgoing call and activate a jamming signal only after the device 106 initiates an outgoing call. When the input 110 is active, the jammer 104 may begin detecting call initiation by the device 106. Such an embodiment may also discern the identity of the device 106 and begin sending the jamming signals 108 after the identity of the device 106 is confirmed.

In other embodiments, the jammer 104 may be used to detect and permit or deny any type of operation of the device 106. For example, calls may be received but placed calls may be jammed. In another example, some calls, such as emergency calls, may be permitted to be placed while other outgoing calls are jammed. Any other function of the device 106 that may be detected may be selectively permitted or disabled by the jammer 104.

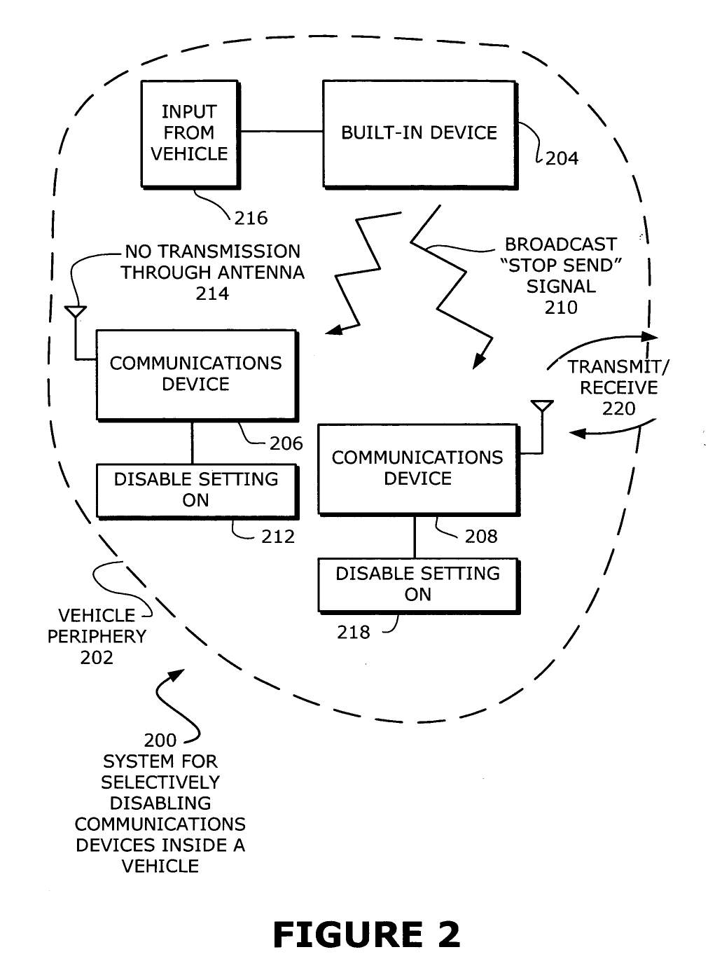

FIG. 2 illustrates an embodiment 200 of a system for selectively disabling communication devices inside a vehicle. Within the vehicle periphery 202, a device 204 is able to send communications to two communication devices 206 and 208 by sending a ‘stop send’ broadcast signal 210. The communications device 206 receives the signal 210, analyzes its setting 212, and based on the setting 212, ceases any transmission through its antenna 214. Communications device 208 receives the same signal 210, analyzes its setting 218 which permits transmissions, and the device 208 may transmit and receive communications 220.

Embodiment 200 illustrates an example of an ‘adolescent chip’ or special condition of a cellular phone that might be used by a teenager. The teenager's cellular phone or other communications device may be disabled when used in a car equipped with the device 204. In some situations, the device 204 may send a signal 210 that only affects a single, specifically programmed communications device 206, or the device 204 may affect every communications device 206 that may have the general setting 212.

In other embodiments, the cellular phone or device 206 may be specially programmed to be disabled during vehicle operation as a general safety measure. In such cases, insurance companies may offer discounts or other incentives for installing such systems, or such systems may be mandated by law or decreed by a judge's verdict in the case of a traffic infraction.

The communications device 206 may receive the signal 210 and operate in a reduced function mode. For example, the device 206 may be prohibited from initiating a phone call except for emergency calls to 911. In another example, the device 206 may be permitted to receive all calls or calls from a predefined list of callers while being prohibited from placing calls. Various reduced function modes may be used and in some embodiments, the setting 212 may define the precise operations allowed.

The setting 212 may be a setting enabled or disabled by a user. In some situations, an adolescent may have the setting enabled or disabled by a parent or guardian and may be password protected. In other situations, the communications service provider may have the ability to enable or disable the feature. In still other situations, the setting may be enabled or disabled by the device manufacturer.

The device 208 may not have a disable setting at all and may be permitted to transmit and receive communications 220. In such a case, the device 208 may be a legacy device or may be sold configured without the setting 218.

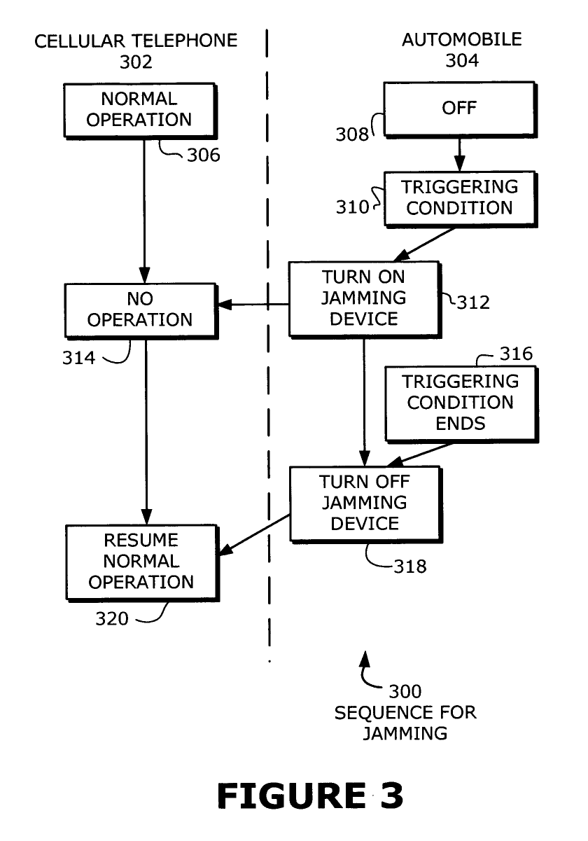

FIG. 3 is a timeline representation of an embodiment 300 showing a sequence for jamming a communications device. The operations of a cell phone 302 or other communications device are shown on the left while the operations of a vehicle such as an automobile 304 are shown on the right. The cell phone 302 begins in normal operation in block 306 while the automobile is off in block 308. After a triggering condition exists in block 310, a jamming device is turned on in block 312. The operation in block 312 causes the cell phone to cease operation in block 314. When the triggering condition ends in block 316, the jamming device is turned off in block 318, and the cell phone may resume normal operation in block 320.

The embodiment 300 illustrates a simple example of the operational sequence of a jamming device and its effects on a communication device, where the jamming device is turned on and off by a triggering condition. The triggering condition in block 310 may be the activation of a switch such as the ignition switch on a car or deactivation of a ‘park’ sensor of an automatic transmission.

While the jamming device is turned on in block 312, the cell phone or other communication device is not operational or is in a state of limited capacity in block 314. This state may be achieved by forcibly interfering with the communication mechanism of the cell phone by broadcasting noise or other signals on one or more channels used by the cell phone 302. In other embodiments, a communications signal may be transmitted by the jamming device of block 312 and interpreted by the cell phone to disable one or more functions of the cell phone. In such an embodiment, the jamming device may communicate with the cell phone through a secondary channel, such as a Bluetooth wireless connection or any other connection that is secondary to the primary cellular communication channel. In some embodiments, the jamming device may communicate on the cell phone's primary communication channel only or in addition to one or more secondary channels.

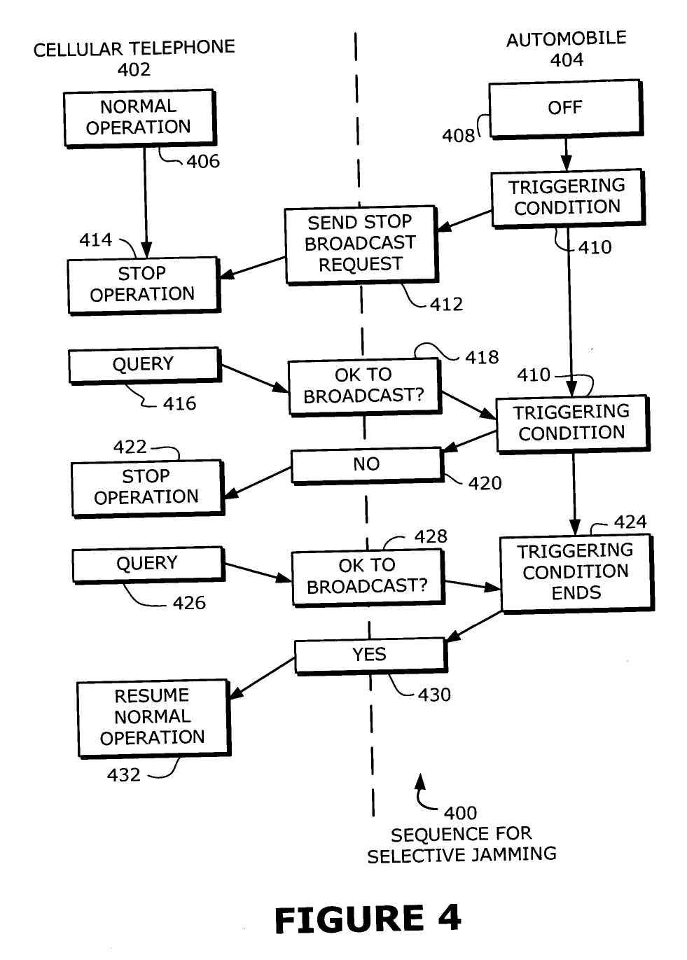

FIG. 4 is a timeline representation of an embodiment 400 of a communication sequence for selective jamming of a cell phone. The operations of a communications device such as a cell phone 402 are shown on the left, while the corresponding communications of a device mounted in an automobile 404 or other vehicle are shown on the right. The cell phone begins in a normal operating mode of box 406 while the automobile is off in block 408. When a triggering condition begins in block 410, a stop broadcast request is sent in block 412 to the cell phone, which stops operation in block 414.

After a period of time, a query in block 416 may generate an ok to broadcast request in block 418. Since the triggering condition exists in block 410, a negative answer in block 420 may be communicated back to the cell phone, which continues in a halted state in block 422.

After another period of time, a query in block 426 may generate an ok to broadcast request in block 428. Because the triggering condition ended in block 424, an affirmative message is communicated in block 430, enabling normal operation to resume in block 423.

The embodiment 400 illustrates an embodiment where a jamming device located in a vehicle can communicate with a communications device in a two way mode to cease some or all of the operations of the communications device. In such an embodiment, the ‘jamming device’ may not actually broadcast a signal that interferes with a signal from the communications device, but sends a command or status to the communications device that is interpreted to cease some or all of its operations.

The queries of blocks 416 or 426 may be made at repeated intervals. In some cases, the intervals may be regular and predetermined, such as every minute, or the intervals may be random. In some embodiments, the queries 416 and 426 may be generated when a user initiates action on the cell phone 402. For example, a user may press any key on the cell phone 402 to initiate a query, or only certain keys, situations, or conditions on the cell phone 402 may initiate a query.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
a transmitter capable of transmitting a signal adapted to interfere with a communications device operated within a vehicle;
an input from said vehicle indicating that said vehicle is in a safe state for transmission, said input having a safe indication and an unsafe indication;
wherein said transmitter is adapted to transmit said signal when said input has an unsafe indication.

2. The device of claim 1 wherein said vehicle is a land vehicle.

3. The device of claim 1 wherein said input comprises an ignition switch.

4. The device of claim 1 wherein said input comprises a park sensor.

5. The device of claim 1 wherein said input comprises a speed sensor.

6. The device of claim 1 wherein said communications device is a two-way communications device capable of transmitting and receiving voice communications.

7. The device of claim 6 wherein said communications device comprises a cellular telephone transceiver.

8. The device of claim 1 further comprising:
a communications mechanism adapted to query said communications device, determine that said communications device has a jamming indicator;
wherein said device is further adapted to transmit said signal when said jamming indicator is present.

9. A device comprising:
a two-way voice communications transceiver;
an indicator;
a mechanism for communicating with a second device and receiving a signal from said second device, said second device being collocated in a vehicle with said device;
said device adapted to enter into a reduced functionality based on said signal and said indicator.

10. The device of claim 9 wherein said two-way voice communications transceiver comprises a cellular telephone.

11. The device of claim 9 wherein said vehicle is a land vehicle.

12. The device of claim 9 wherein said vehicle is an aircraft.

13. The device of claim 9 wherein said second device comprises an input.

14. The device of claim 13 wherein said input comprises an ignition switch.

15. The device of claim 13 wherein said input comprises a park sensor.

16. A method comprising:
receiving an input from a vehicle, said input being transmitted inside said vehicle and received inside said vehicle;
determining a value of a setting within a two-way communications device; and
halting communications on said two-way communications device based on said input and said value.

17. The method of claim 16 wherein said communications is performed using a first frequency band and said receiving performed using a second frequency band.

18. The method of claim 16 wherein said communications is performed using a first communications protocol and said receiving performed using a second communications protocol.

19. The method of claim 16 wherein said two-way voice communications transceiver comprises a cellular telephone.

20. The method of claim 16 wherein said vehicle is a land vehicle.
